(19) United States
(12) Patent Application Publication
(10) Pub. No.: US 2020/0020039 A1
(43) Pub. Date: Jan. 16, 2020

(54) METHOD FOR SPECIFIED COMMERCIAL REAL ESTATE INVESTMENT AND PRINCIPAL PROTECTION

(71) Applicant: Iintoo Investments Ltd., Tel-Aviv (IL)

(72) Inventor: Eran Roth, New York, NY (US)

(73) Assignee: Iintoo Investments Ltd., Tel-Aviv (IL)

(21) Appl. No.: 16/034,484

(22) Filed: Jul. 13, 2018

(51) Int. Cl. G06Q 40/08; G06Q 50/16

(52) U.S. Cl. CPC G06Q 40/08; G06Q 50/16

(57) ABSTRACT

Disclosed herein is an commercial real estate investment system for individual investors to obtain an equity or debt interest and earn income from selectively investing in commercial real estate such that individual investors are provided with equity protection from at least two sources of funding in the nature of a retention account and an insurance policy, which provide funding for covering losses incurred on the nominal principal amount of their respective investment.

### FIELD OF THE INVENTION

The present application generally relates to a system for individual investors to obtain an equity interest and earn income from selectively investing in commercial real estate such that individual investors are provided with equity protection from at least two sources of funding in the nature of a retention account and an insurance policy, which provide funding for covering losses incurred on the nominal principal amount of their respective investment.

### BACKGROUND OF THE INVENTION

The graph below shows that since 1980 average annual returns in commercial real estate (“CRE”) returns have been nearly equal to those of regulated securities such as stocks. Yet the volatility of returns in the stock market has been much higher than the volatility of returns in CRE. Further, the ratio of return-to-volatility of CRE is substantially higher than that of both regulated securities and real estate investment trusts, also known as “REITS”. This means that while the average returns in the two asset classes are nearly equal, stocks are much riskier than CRE.

Specific regard is made to real estate investments in multiple properties or portfolios of real estate interests, such as REIT's, which operate in a manner comparable to mutual funds as they allow for individual investors to acquire ownership in commercial real estate portfolios that receive income from properties such as apartment complexes, hospitals, office buildings, hotels and shopping malls. However, individual investors in REIT's, (1) have limited to no knowledge of the specific real estate interests included within a REIT, (2) have no control over the specific amount or proportion of principal investment in the respective specific commercial real estate properties included in a REIT as the choices of real estate properties included in a REIT are fixed, and most important, (3) REIT's provide no protection to individual investors from losses incurred in the value of the principal amount of their investment in the real estate interests included within a REIT, which negatively effect the amount and regularity of dividends or other income earned through a REIT.

Given the limitations on returns of stocks and REIT's, the high risks and lack of protection to an investor's principal amounts invested in such conventional equities, there is a need for a CRE investment system that has the potential for significantly higher rates of return to individual investors, provides investors with the ability to select specific commercial real estate properties in which to direct their respective principal investment and that, most importantly, provides a means for an individual investor to recover and/or protect its nominal principal investment amount from losses incurred to the income generated by or value of the respective commercial real estate properties included within a REIT.

### BRIEF SUMMARY OF THE INVENTION

Before the present systems and methods are described, it is to be understood that this application is not limited to the particular systems, and methodologies described, as there can be multiple possible embodiments which are not expressly illustrated in the present disclosures. It is also to be understood that the terminology used in the description is for the purpose of describing the preferred embodiments only, and is not intended to limit the scope of the present application.

The commercial real estate investment system of the present invention is preferably structured through a series of affiliated corporate entities and controlled by a general partner (preferably a Delaware LLC) of limited partnerships or the managing member of limited liability companies formed for investment purposes.

A commercial real estate investment system in accordance with the present invention includes, at least one specific commercial real estate property (“SCRE”) from which income may be derived, a general partner (“GP”), preferably a limited liability corporation, at least one joint venture entity (“JV Entity”), said JV Entity having a fee simple ownership or comparable direct ownership in at least one SCRE, said JV Entity further comprising, a limited entity (“Limited Entity”). The Limited Entity comprises a limited partnership or a limited liability corporation, controlled by said GP and formed for purposes of investing and having an equity interest in at least one JV Entity, said equity interest of said Limited Entity in the JV Entity being held directly or through a wholly owned subsidiary, and a real estate sponsor, formed for managing said JV Entity and also holding an equity interest in at least one JV Entity, said equity interest of said real estate sponsor being any remaining equity in the JV Entity and held either directly by said real estate sponsor or together with other investors; at least one limited investor (“Limited Investor”), said Limited Investor selectively purchasing equity or debt in one or more of said Limited Entities, said Limited Investor receiving an equity or debt interest in said Limited Entity.

The SCRE investment system of the present invention further provides two layers of equity protection for covering losses incurred against principal investment amounts of the equity investments (including fees paid) by each Limited Investor. The first layer of equity protection comprises, a retention account funded by at least one Limited Entity in amounts comprising excess returns, such excess returns calculated as returns generated from a respective Limited Entity in excess of the principal investment amounts of the Limited Investor in the said Limited Entity, plus at least a 7% per annum yield over the term of the Limited Entity investment.

The second layer of equity protection comprises an insurance policy issued by a regulated insurance carrier and purchased by said GP, said policy naming at least one said Limited Entity as a loss payee of said policy, and said policy covering losses incurred on principal investment amounts of the Limited Investor in the Limited Entity to the extent such losses exceed an available balance of said retention account.

These two layers of equity protection enable the GP to provide a contractual guaranty to at least one Limited Entity, for indemnifying the Limited Entity from either said retention account or said insurance policy for losses incurred on all principal investment amounts. Accordingly, at least one Limited Entity may provide a contractual guaranty to each respective Limited Investor for paying proceeds, received through said guaranty between each Limited Entity and said GP, to each respective Limited Investor to cover losses on said principal investment amounts.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 illustrates a flow chart in accordance with the Specified Commercial Real Estate Investment and Principal Protection System of the present subject matter. FIG. 1 depicts only one example of a preferred embodiment, which shows the Specified Commercial Real Estate Investment and Principal Protection System having two respective Limited Entities, Joint Venture Entities and SCRE's, but it is understood that alternate embodiments may include many more of each such entity for a particular Specified Commercial Real Estate Investment and Principal Protection System of the present subject matter.

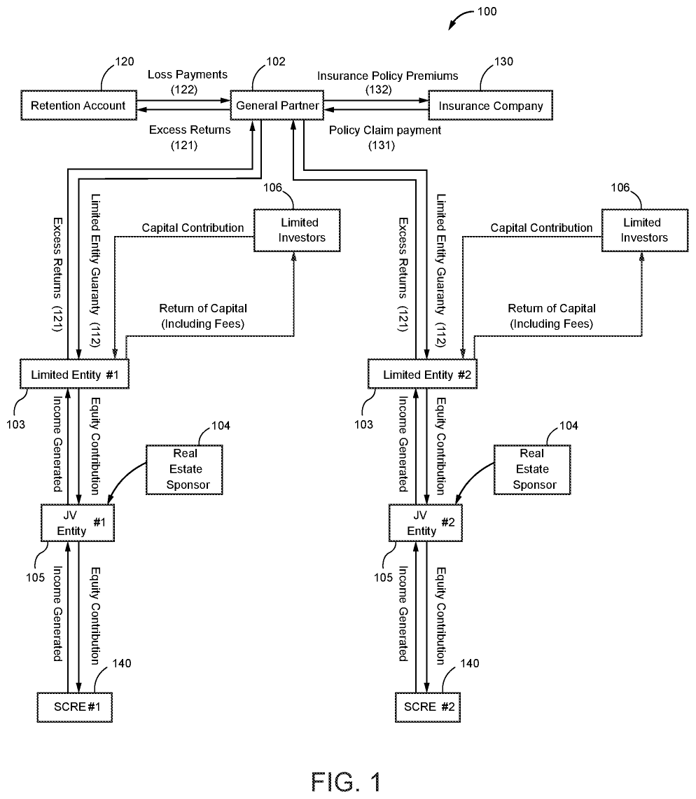

### DETAILED DESCRIPTION

In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In an embodiment of the present invention, a commercial real estate investment system is provided (100) and is preferably structured through a series of affiliated corporate entities and controlled by a general partner (102) (preferably a Delaware LLC) of limited partnerships or the managing member of limited liability companies formed for investment purposes.

Such corporate entities will offer to individual investors (pursuant to transactions that are exempt from registration under the U.S. federal securities laws) and offshore investors (under Regulation S), limited partner or member interests, as applicable, in a respective limited partnership or limited liability company relating to an underlying investment in real property (“Limited Investment”).

Such individual investors and Regulation S investors (each a “Limited Investor”) (106) will not actively participate in the management or activities of any of the limited partnerships or the limited liability companies (each a “Limited Entity”) (103) but will be passive investors.

Each Limited Entity (103) is to be preferably formed and organized under the laws of Delaware with its principal place of business in New York and will provide funding preferably in a single tranche to a joint venture entity that is owned jointly by the Limited Entity and an unaffiliated real estate developer or other third parties unaffiliated with the Limited Entity (“Real Estate Sponsor”) (104), that invests directly (or through a 100% subsidiary) in specific commercial real estate (such entity the “JV Entity” (105) and such specific commercial real estate, the “SCRE” (140)).

The SCRE (140) preferably will be selected, without limitation, from any of the following types of income generating properties:
multi-family residential building,
shopping center,
student housing complex,
renovated building for re-sale,
commercial development, or
other commercial property that is, (1) income producing or deferred income producing and (2) located in the U.S., U.K., Spain, Netherlands or Israel (each a “JV Investment”).

A principal and preferred aspect of the SCRE investment system of the present invention is to provide two sources of protection of the principal amount invested (inclusive of fees paid by each Limited Investor) by the limited partners in certain Limited Entities (103) of which it is the general partner.

Such protection preferably is in the form of an unsecured contractual commitment by the applicable Limited Entity (103) to its Limited Investors (106) to indemnify them for losses on the nominal principal amount of their investment (“Limited Entity Guaranty) (112).

The Limited Entity Guaranty is preferably supported by two distinct sources of financing. The first source is an account (“Retention Account”) (120) that is preferably self-funded by the participating Limited Entities (103), in an amount equal to excess returns, if any, produced by all such participating Limited Entities, which are to be made available to support claims for indemnification pursuant to the equity protection by any or all of the Limited Entities.

For purposes of the present invention “Excess Returns” (121) are defined preferably as returns generated by such Limited Entity through its investment in the JV Entity, in excess of a predefined threshold (e.g., 5% to 7% annually), such returns to be paid over and segregated in the Retention Account (120). All Excess Returns are inclusive of fees paid by each Limited Investor.

It is preferred that the organizational documents of the applicable Limited Entities (103) specify that Limited Investors (106) would not have the right to receive returns, if any, from the Limited Entity, in excess of the Excess Returns (121) percentage, except under specified circumstances set forth in advance in such organizational documents.

Once funded into the Retention Account (120), money deposited by any one of the Limited Entities (103), would be available to support claims for indemnification pursuant to the Limited Entity Guaranty (112) by any or all of the Limited Entities participating in the fund. However, neither the Limited Entities nor the Limited Investors (106) will have an immediate entitlement, under the terms of the agreement creating the Limited Entity or any other agreement, to any of the deposited funds at the time they are deposited in the Retention Account (120) to the extent that losses are not incurred.

Entitlement to funds in a Retention Account would accrue only to the Limited Entities (103), and only in the event of claims for loss payments (122) pursuant to the Limited Entity Guaranty (112) or (to the extent set forth in the organizational documents of the relevant Limited Entities) if residual funds remain at the end of the Retention Account period. Further such Excess Returns (121) may be preferably deposited in a Retention Account (120), which is a trust account and held by a trustee, which may be deemed to provide an economic benefit for the Insurer (as described below).

Such residual fund amounts may be deemed to provide an economic benefit to the Insurer (130) because the Insurer will be liable for losses under the Policy (131) solely to the extent that losses exceed the amounts in the Retention Account (120). Once the funds are paid by the participating Limited Entities into the Retention Account, the Limited Entities have no ownership interests or rights in the funds or in the account other than as set forth in this paragraph.

A second layer of support for the Limited Entity Guaranty (112), will be from an insurance policy purchased through insurance policy premiums (132) by the GP (102) for the benefit of the participating Limited Entities (103) and as such the GP would enter into an insurance contract. The Insurance Policy and payment of premiums (132) is preferably issued by a major insurance company regulated in the United States (the “Insurer”) (130), to cover the losses of the principal amount invested (inclusive of fees) of each such Limited Investment in excess of the amounts available in the Retention Account (120), if any.

The purpose of the Policy is to indemnify the GP (102) through policy claim payments (131), which will provide proceeds of the Policy to the Limited Entities (103) by means of a loss payee provision in the Policy as indemnification, if at the time of the SCRE Termination Date (as defined below) the amount yielded on the sale of the SCRE is less than the principal amount of the total investments by the Limited Partners in a covered Limited Entity.

For purposes of the present invention the “SCRE Termination Date” is defined as the earlier of, (i) the date such Limited Investment is sold in an arm's length transaction to a third party unrelated to the Real Estate Sponsor and any of its affiliates or the Limited Entity, the GP, and any of their affiliates and such money is received by the Limited Entity, (ii) the date the Real Estate Sponsor or any affiliate purchases such Limited Investment if such purchase is for an amount that would not cause a loss and such money is received by the Limited Entity, (iii) the date such Limited Investment is sold to any party with the prior written approval of the Insurer and such money is received by the Limited Entity, (iv) the date that is seven (7) years from the closing date of such Insured Investment if there has been no occurrence of a sale as per (i), (ii) or (iii) above prior to such date, or (v) with the prior written agreement of the Insurer, such later date as may be requested by the GP and agreed to by the Insurer in writing and there has been no occurrence of a sale as per (i), (ii) or (iii) above

The terms of the Policy from the Insurance Company (130) are preferably described in the agreements entered into by the Limited Entity (103) and its respective Limited Investor (106), such that no certificates of insurance will be issued to the Limited Investors and each Limited Entity will be named as the loss payee in the Policy.

A further preferred function of the Policy of the Insurance Company (130) is to provide a second source of financing, if the Retention Account (120) amounts are exhausted or not available to support a claim or claims for loss payments (122), more specifically, the indemnity for which the Insurer (130) is to be liable is an amount equal to: (i) the difference, if negative, of (A) the sum of all funds that were generated for a Limited Entity from a JV Investment (including its sale), less (B) the principal investment amount (including fees) of the limited partners in such Limited Entity (103), plus, (ii) the available Excess Returns (121) in the Retention Account (120). (The GP is not eligible for indemnification of its economic losses, if any, under the Policy.)

It is a further aspect of the Policy (131) that the GP (102) will reimburse the Insurer (130) for losses paid, if Excess Returns (121) are available on a later date (up to a predetermined maximum period) by amounts, which would have been available to support the paid claim, if the Excess Return would have been generated earlier. For example, if the proposed Retention Account (120), based upon its calculation methodology, is $0, then the policy will be a primary (dollar one) policy and conversely if during the predetermined period the Retention Account is replenished, such subsequently generated returns will be owed to the Insurer in respect of the retention obligation of the Policy.

In another preferred embodiment of the present invention the Policy from the Insurance Company (130) will have an annual policy period, an individual total Loss per Limited Investment of $5,000,000, an aggregate Policy limit of $40,500,000 (representing 27% of the aggregate of permitted maximum amount of insured investments of $150,000,000) for all investments subject to the Policy secured by payment of insurance policy premiums (132) and exclusions to be set forth in the Policy.

We claim:

1. A commercial real estate investment system, comprising:
at least one specific commercial real estate property (“SCRE”) from which income may be derived,
a general partner (“GP”), consisting of a limited liability corporation,
at least one joint venture entity (“JV Entity”), said JV Entity having a fee simple ownership or comparable direct ownership in at least one SCRE, said JV Entity further comprising,
a limited entity (“Limited Entity”), comprising a limited partnership or a limited liability corporation, controlled by said GP and formed for purposes of investing and having an equity interest in at least one JV Entity, said equity interest of said Limited Entity in the JV Entity being held directly or through a wholly owned subsidiary, and
a real estate sponsor, formed for managing said JV Entity and also holding an equity interest in at least one JV Entity, said equity interest of said real estate sponsor being any remaining equity in the JV Entity and held either directly by said real estate sponsor or together with other investors;
At least one limited investor (“Limited Investor”), said Limited Investor selectively purchasing equity or debt in one or more of said Limited Entities, said Limited Investor receiving an equity or debt interest in said Limited Entity;
Whereby, said SCRE investment system provides two layers of equity protection for covering losses incurred against principal investment amounts of said equity investments by each said Limited Investor, said equity protection comprising,
a retention account funded by at least one Limited Entity in amounts comprising excess returns, such excess returns calculated as returns generated from a respective Limited Entity in excess of the principal investment amounts of the Limited Investor in the said Limited Entity, plus at least a 7% per annum yield over the term of the Limited Entity investment, and
an insurance policy purchased by said GP, said policy naming at least one said Limited Entity as a loss payee of said policy, and said policy covering losses incurred on principal investment amounts of the Limited Investor in the Limited Entity to the extent such losses exceed an available balance of said retention account; and
Whereby, said GP providing a contractual guaranty to said at least one Limited Entity, for indemnifying said Limited Entity from either said retention account or said insurance policy for losses incurred on said principal investment amounts, and said at least one Limited Entity providing a contractual guaranty to each respective Limited Investor for paying proceeds, received through said guaranty between each Limited Entity and said GP, to each respective Limited Investor to cover losses on said principal investment amounts.

2. The commercial real estate investment system of claim 1, wherein said GP will reimburse said Insurer for losses paid from said Policy, provided that said Excess Returns are available on a later date, said date limited by a predetermined maximum period, for amounts, which would have been available to support a payment of losses to Limited Entities, and thereafter from said Limited Entities to said Limited Investors, if said Excess Returns had been generated earlier.

3. The commercial real estate investment system of claim 1, wherein said GP receives a success fee from at least a portion of a remaining balance of funds in said Retention Account after payment of all losses to one or more Limited Investors.
